(19) United States
(12) Patent Application Publication
(10) Pub. No.: US 2023/0143724 A1
(43) Pub. Date: May 11, 2023

(54) METHOD FOR BEAM REPORT IN WIRELESS COMMUNICATION SYSTEM WITH BEAMFORMING

(71) Applicant: MediaTek INC., Hsin-chu (TW)

(72) Inventor: CHENG-RUNG TSAI, Hsin-Chu (TW)

(21) Appl. No.: 18/091,926

(22) Filed: Dec. 30, 2022

Related U.S. Application Data
(63) Continuation of application No. PCT/CN21/04941, filed on Jul. 7, 2021.
(60) Provisional application No. 63/048,738, filed on Jul. 7, 2020.
(60) Provisional application No. 63/070,351, filed on Aug. 26, 2020.
(60) Provisional application No. 63/150,158, filed on Feb. 17, 2021.

(51) Int. Cl. H04B 7/06; H04L 5/00

(52) U.S. Cl. CPC H04B 7/0691; H04L 5/0051

(57) ABSTRACT

A method for beam report associated with one or more antenna group configurations (AGCs) is proposed. The network node configures one or more AGCs. Each AGC may comprise at least one of an AGC index. Each AGC may comprise the number of ports or layers that can be supported by the UE. In addition, each AGC may comprise an active panel state. The active panel state may indicate whether the UE can perform UL transmission to the network node and/or whether the UE can perform DL reception from the network node. The UE may determine one of the AGCs for each CRI or SSBRI in a beam report. The UE may activate and select one or more panels for DL reception and UL transmission and the UE may receive and measure the reference signal corresponding to the CRI or SSBRI in the beam report.

### CROSS REFERENCE TO RELATED APPLICATIONS

This application is filed under 35 U.S.C. §111 (a) and is based on and hereby claims priority under 35 U.S.C. §120 and §365(c) from International Application No. PCT/CN2021/104941, with an international filing date of Jul. 7, 2021, which in turn claims priority from U.S. Provisional Application No. 63/048,738, filed on Jul. 7, 2020; U.S. Provisional Application No. 63/070,351, filed on Aug. 26, 2020; and U.S. Provisional Application No. 63/150,158, filed on Feb. 17, 2021. This application is a continuation of International Application No. PCT/CN2021/104941, which claims priority from U.S. provisional applications 63/048,738, 63/070,351, and 63/150,158. International Application No. PCT/CN2021/104941 is pending as of the filing date of this application, and the U.S. is a designated state in International Application No. PCT/CN2021/104941. The disclosure of each of the foregoing documents is incorporated herein by reference. the subject matter of which is incorporated herein by reference.

### TECHNICAL FIELD

The disclosed embodiments relate generally to wireless communication, and, more particularly, to beam reporting associated with one or more antenna group configurations (AGCs).

### BACKGROUND

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

With recent advances in mmWave semiconductor circuitry, mmWave wireless system has become a promising solution for real implementation. However, the heavy reliance on directional transmissions and the vulnerability of the propagation environment present particular challenges for the mmWave network. In general, a cellular network system is designed to achieve the following goals: 1) Serve many users with widely dynamical operation conditions simultaneously; 2) Robust to the dynamics in channel variation, traffic loading and different QoS requirement; and 3) Efficient utilization of resources such as bandwidth and power. Beamforming adds to the difficulty in achieving these goals.

In principle, for a compact mobile device, since the place holders for antenna modules are usually limited and vary in size, different panels equipped on a user equipment (UE) may not have identical configurations, e.g. the number of ports. UE can report the supported maximum number of ports or layers for uplink (UL) transmission through capability signaling. However, this number is usually determined according to the panel with the smallest number of antennas since it should be supported by every panel that may be used for UL transmission. Furthermore, even penal capability is reported from UE, network still cannot know if the selected network node (e.g., gNB) beam base on the beam reporting is used for UL transmission, what is the maximum number of ports or layers that can be supported by the UE-selected UL panel.

In addition, for a UE equipped with multiple panels with identical configurations, a panel configuration still can be changed for power saving of UE. Down link (DL) MIMO layer adaption supported by Bandwidth Part (BWP) switching is for power saving of UE. For UL, it is also beneficial for power saving of UE if the maximum UL MIMO layers on the UL panel can adapt dynamically. However, it is not possible to let network know the change of UL panel configuration based on current specification.

Furthermore, even there could be more than one activated panel, UE still can select only one UL panel from them. For example, in order to avoid transmit power back-off due to maximum permissible exposure (MPE), UE may select a panel for UL transmission alternative to a panel for DL reception. If multiple panels are activated and only one of the panels is selected for UL transmission, network has to know how to schedule UL transmission on the UL panel. However, network cannot differentiate which gNB beam(s) corresponds to the UL panel selected by UE based on beam reporting.

Beam reporting for activated panel is thus an essential part needs to be determined.

### SUMMARY

A method for beam report associated with one or more antenna group configurations (AGCs) is proposed. The network node configures one or more AGCs. Each AGC may comprise at least one of an AGC index. Each AGC may further comprise the number of ports or layers that can be supported by the UE. In addition, each AGC may further comprise an active panel state. The active panel state may indicate whether the UE can perform uplink (UL) transmission to the network node and/or whether the UE can perform downlink (DL) reception from the network node. The UE may determine one of the AGCs for each channel-state-information reference-signal (CSI-RS) resource index (CRI) or synchronization signal block (SSB) resource index (SSBRI) in a beam report. The UE may activate and select one or more panels for DL reception and UL transmission and the UE may receive and measure the reference signal (RS) corresponding to the CRI or SSBRI in the beam report on the activated panel(s). The UE may perform the UL transmission to the network node according to the RS and/or perform the DL reception from the network node according to the RS.

In one embodiment, a UE receives one more antenna group configurations (AGCs) configured by a network node in a beamforming wireless communication network, wherein each AGC comprises at least one of an AGC index. The UE reports at least one of the AGC index in a beam report to the network node.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified block diagram of a network node and a user equipment that carry out certain embodiments of the present invention.

FIG. 2 illustrates an example of AGCs configured by the network node.

FIG. 3 illustrates a first embodiment of a panel-aware beam report of a UE having multiple panels.

FIG. 4 illustrates a second embodiment of a panel-aware beam report of a UE having multiple panels.

FIG. 5 illustrates a third embodiment of a panel-aware beam report of a UE having multiple panels.

FIG. 6 is a flow chart of a method for beam report from UE perspective in a beamforming wireless communication system in accordance with one novel aspect.

### DETAILED DESCRIPTION

Reference will now be made in detail to some embodiments of the invention, examples of which are illustrated in the accompanying drawings.

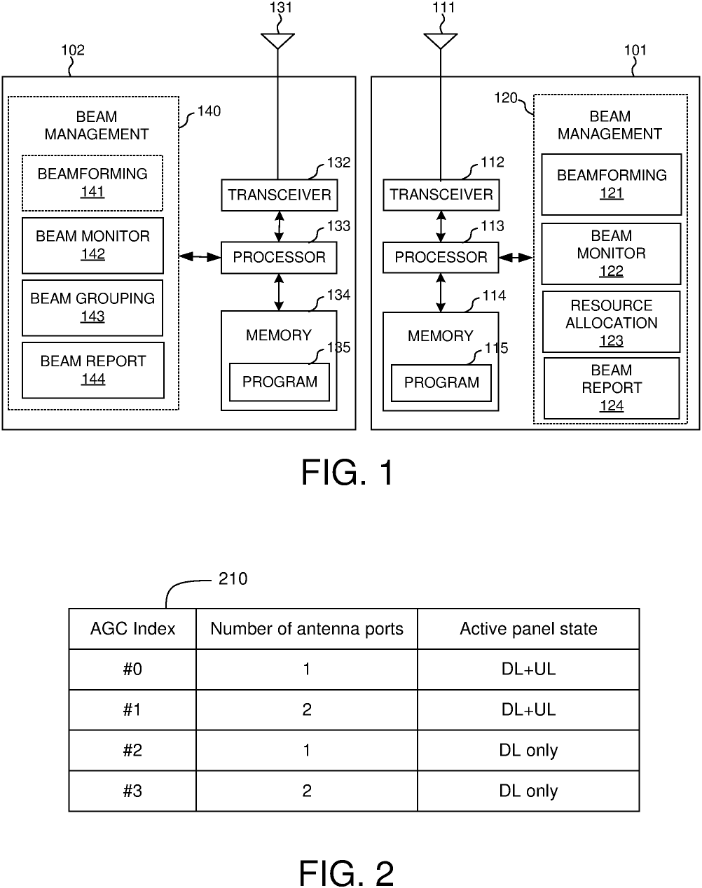

FIG. 1 is a simplified block diagram of a network node and a user equipment (UE) that carry out certain embodiments of the present invention. The network node 101 may be a base station (BS) or a gNB, but the present invention should not be limited thereto. The UE 102 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

Network node 101 has an antenna array 111 having multiple antenna elements that transmits and receives radio signals, one or more RF transceiver modules 112, coupled with the antenna array, receives RF signals from antenna 111, converts them to baseband signal, and sends them to processor 113. RF transceiver 112 also converts received baseband signals from processor 113, converts them to RF signals, and sends out to antenna 111. Processor 113 processes the received baseband signals and invokes different functional modules to perform features in network node 101. Memory 114 stores program instructions and data 115 to control the operations of network node 101. Network node 101 also includes multiple function modules that carry out different tasks in accordance with embodiments of the current invention.

Similarly, UE 102 has an antenna 131, which transmits and receives radio signals. A RF transceiver module 132, coupled with the antenna, receives RF signals from antenna 131, converts them to baseband signals and sends them to processor 133. RF transceiver 132 also converts received baseband signals from processor 133, converts them to RF signals, and sends out to antenna 131. Processor 133 processes the received baseband signals and invokes different functional modules to perform features in UE 102. Memory 134 stores program instructions and data 135 to control the operations of UE 102. UE 102 also includes multiple function modules and circuits that carry out different tasks in accordance with embodiments of the current invention.

The functional modules and circuits can be implemented and configured by hardware, firmware, software, and any combination thereof. For example, network node 101 comprises a beam management module 120, which further comprises a beamforming circuit 121, a beam monitor 122, a resource allocation circuit 123, and a beam reporting circuit 124. Beamforming circuit 121 may belong to part of the RF chain, which applies various beamforming weights to multiple antenna elements of antenna 111 and thereby forming various beams. Beam monitor 122 monitors received radio signals and performs measurements of the radio signals over the various UE beams. Resource allocation circuit 123 allocates one or more antenna group configurations (AGCs). Beam reporting circuit 124 reports the beam monitoring results for each received UE beam.

Similarly, UE 102 comprises a beam management module 140, which further comprises a beamforming circuit 141, a beam monitor 142, a beam grouping circuit 143, and a beam report circuit 144. Beamforming circuit 141 may belong to part of the RF chain, which applies various beamforming weights to multiple antenna elements of antenna 131 and thereby forming various beams. Beam monitor 142 monitors received radio signals and performs measurements of the radio signals over the various beams. Beam grouping circuit 143 groups different BS beams into beam groups based on RS resource configuration. Beam report circuit 144 provide beam quality metric and send report to network node 101 in beam groups based on the beam monitoring results for each BS beam.

In accordance with one novel aspect, a beamforming wireless communication network or a beamforming wireless communication network system comprises the network node 101 and the UE 102. The beamforming wireless communication network uses directional communication with narrow beams and can support multi-gigabit data rate. Directional communication is achieved via digital and/or analog beamforming, wherein multiple antenna elements are applied with multiple sets of beamforming weights to form multiple beams.

In accordance with one novel aspect, the network node 101 configures one or more antenna group configurations (AGCs). Each AGC may comprise at least one of an AGC index. Each AGC may further comprise the number of ports or layers that can be supported by the UE 102. In addition, each AGC may further comprise an active panel state. Each panel may comprise one or more antennas and/or ports (e.g., a group of antennas). The active panel state may indicate whether the UE 102 can perform uplink (UL) transmission to the network node 101 and/or whether the UE 102 can perform downlink (DL) reception from the network node 101.

In accordance with one novel aspect, the UE 102 may determine one of the AGCs for each channel-state-information reference-signal (CSI-RS) resource index (CRI) or synchronization signal block (SSB) resource index (SSBRI) in a beam report. In the beam report, each CRI or SSBRI may correspond to an AGC index of the AGCs and a reporting quantity (e.g. L1-reference symbol received power (RSRP) or L1-signal to interference plus noise ratio (SINR)). In addition, the CRI or the SSBRI may be associated with the active panel state of the AGC that indicates the UE 102 can perform UL transmission to the network node 101 and/or the UE 102 can perform downlink (DL) reception from the network node 101. The UE 102 may activate and select one or more panels for DL reception and UL transmission and the UE 102 may receive and measure the reference signal (RS) corresponding to the CRI or SSBRI in the beam report on the activated panel(s). The processor 233 of the UE 102 may perform the UL transmission to the network node 101 according to the RS and/or perform the DL reception from the network node 101 according to the RS. Each panel activated by the processor 233 of the UE 102 is associated with an AGC. The UE 102 may transmit the beam report associated with the AGCs to the network node 101. The UE 102 may report at least one of the AGC index in the beam report to the network node 101.

In accordance with one novel aspect, the receiver of UE 102 can receive the CRIs or SSBRIs associated with different AGCs simultaneously but cannot receive the CRIs or SSBRIs associated with the same AGC simultaneously.

FIG. 2 illustrates an example of AGCs configured by the network node. As depicted by table 210, each AGC may comprise an AGC index (i.e. AGC index #0, AGC index #1, AGC index #2, and AGC index #3), the number of ports of an active panel, and an active panel state. In the example, For AGC index #0, the number of ports of an active panel is 1 and an active panel state is that the active panel selected and activated by the UE is for DL reception and UL transmission. For AGC index #1, the number of ports of an active panel is 2 and an active panel state is that the active panel selected and activated by the UE is for DL reception and UL transmission. For AGC index #2, the number of ports of an active panel is 1 and an active panel state is that the active panel selected and activated by the UE is only for DL reception, i.e., the active panel cannot be used for UL transmission. For AGC index #3, the number of ports of an active panel is 2 and an active panel state is that the active panel selected and activated by the UE is only for DL reception, i.e., the active panel cannot be used for UL transmission.

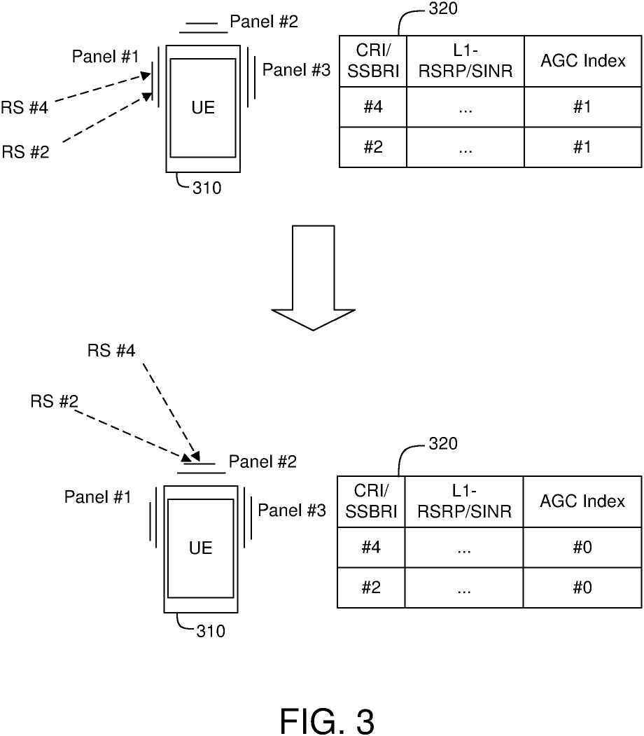

FIG. 3 illustrates a first embodiment of a panel-aware beam report of a UE having multiple panels. As depicted by FIG. 3, UE 310 has three panels, Panel#1, Panel#2 and Panel#3. In the first embodiment of FIG. 3, the Panel#1 supports two ports, the Panel#2 supports one port, and the Panel#3 supports two ports. When the UE 310 selects and activates the Panel#1 for the DL reception and UL transmission and receives the reference signals RS#2 and RS# 4 on the activated Panel#1, the panel-aware beam report 320 may be associated with AGC index#1 as depicted by table 210 of FIG. 2. That is to say, the CRIs or SSBRIs corresponding to the reference signals RS#2 and RS# 4 may in the panel-aware beam report 320 may be associated with AGC index#1. Then, when the UE 310 changes to select and activate the Panel#2 for the DL reception and UL transmission and receives the reference signals RS#2 and RS# 4 on the activated Panel#2, the panel-aware beam report 320 may be associated with AGC index#0 as depicted by table 210 of FIG. 2. Therefore, in the first embodiment of FIG. 3, the network node will know the maximum number of the ports supported by the current activated panel based on the panel-aware beam report 320 even if the activated panel of UE 310 is changed.

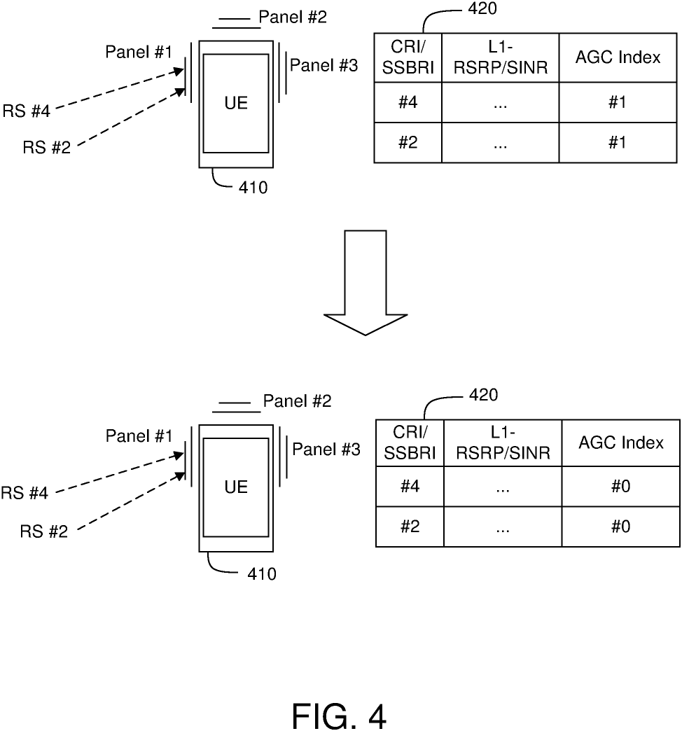

FIG. 4 illustrates a second embodiment of a panel-aware beam report of a UE having multiple panels. As depicted by FIG. 4, UE 410 has three panels, Panel#1, Panel#2 and Panel#3. In the second embodiment of FIG. 4, the Panel#1 supports two ports, the Panel#2 supports two ports, and the Panel#3 supports two ports. When the UE 410 selects and activates the Panel#1 for the DL reception and UL transmission and receives the reference signals RS#2 and RS# 4 on the activated Panel#1, the panel-aware beam report 420 may be associated with AGC index#1 as depicted by table 210 of FIG. 2. Then, when the UE 410 disable one port of activated Panel#1 to save power, the panel-aware beam report 420 may be associated with AGC index#0 as depicted by table 210 of FIG. 2. Therefore, in the second embodiment of FIG. 4, the network node will know the maximum number of the ports supported by the current activated panel based on the panel-aware beam report 420 even if the number of the ports supported by the current activated panel of UE 410 is changed.

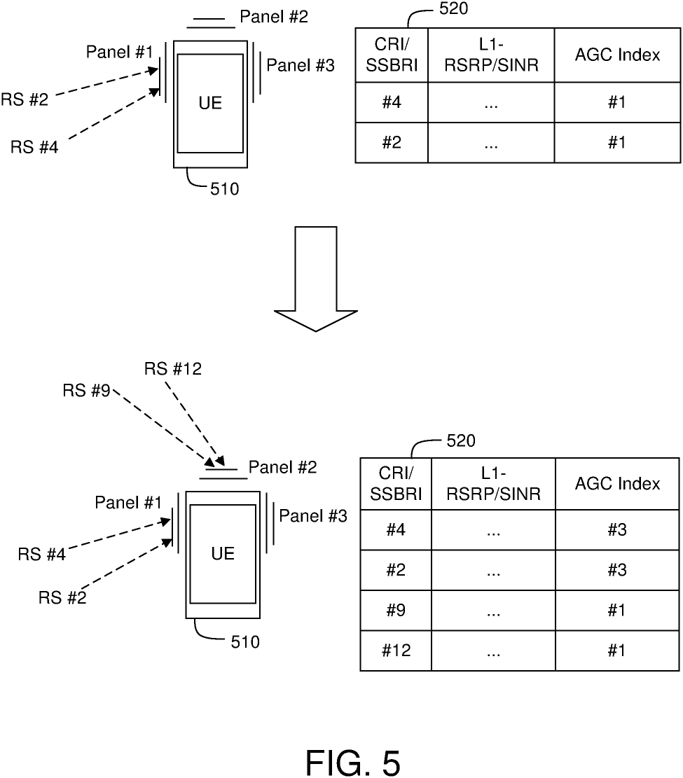

FIG. 5 illustrates a third embodiment of a panel-aware beam report of a UE having multiple panels. As depicted by FIG. 5, UE 510 has three panels, Panel#1, Panel#2 and Panel#3. In the third embodiment of FIG. 5, the Panel#1 supports two ports, the Panel#2 supports two ports, and the Panel#3 supports two ports. When the UE 510 selects and activates the Panel#1 for the DL reception and UL transmission and receives the reference signals RS#2 and RS# 4 on the activated Panel#1, the panel-aware beam report 520 may be associated with AGC index#1 as depicted by table 210 of FIG. 2. Then, when the UE 510 changes to select and activate the Panel#1 only for the DL reception and the Panel#2 for the DL reception and UL transmission, and receives the reference signals RS#2 and RS# 4 on the activated Panel#1 and receives the reference signals RS#9 and RS# 12 on the activated Panel#2, the panel-aware beam report 520 may be associated with AGC index#0 and AGC index#3 as depicted by table 210 of FIG. 2. Therefore, in the third embodiment of FIG. 5, the network node will know how to schedule DL reception and UL transmission based on the panel-aware beam report 520 even if multiple panels are activated by the UE 510.

In accordance with one novel aspect, the network node may configure only one AGC. The UE selects and activates a panel according to the AGC configured by the network node and reports a beam report associated with the AGC. In an example, if the network node configures an AGC with AGC index#0 and the active panel state of this AGC indicates that an active panel is selected for UL transmission and DL reception. The UE may select and activate one panel for DL reception and UL transmission and the UE may receive and measure the reference signal (RS) corresponding to the CRI or SSBRI in the beam report associated with the AGC on the activated panel(s). If the network node configures another AGC with AGC index#2 and the active panel state of this AGC indicates that an active panel is selected only for DL reception. The UE may select and activate another panel for DL reception and the UE may receive and measure the reference signal (RS) corresponding to the CRI or SSBRI in the beam report associated with the AGC on the activated panel(s). In an embodiment of the novel aspect, the receiver of the UE can receive CRIs or SSBRIs in different beam reports associated with different AGCs simultaneously; the receiver of the UE cannot receive the CRIs or SSBRIs in different beam reports associated with the same AGC simultaneously; and the receiver of the UE cannot receive the CRIs or SSBRIs in the same beam report simultaneously.

In accordance with one novel aspect, the receiver of the UE receives a set of Transmission Configuration Indicator (TCI) states configured by the network node via a radio resource control (RRC) signaling. The network node activates one or more TCI states through an MAC control element (MAC-CE). If more than one TCI state is activated by the network node, the network node may indicate one of the activated TCI states for determining spatial Tx filter for UL transmission. If only one TCI state is activated by the network node, the network node may use this activated TCI states for determining spatial Tx filter for UL transmission. In an embodiment, each TCI state associates with an AGC. In another embodiment, each TCI state can be configured with an AGC.

In accordance with one novel aspect, the transmitter of the UE reports a panel-related capability to the network node. The panel-related capability comprises at least one of the maximum number of active panels, the maximum number of panels, the maximum number of configured AGCs, the maximum number of ports or layers of a panel and the supported active panel state of a panel.

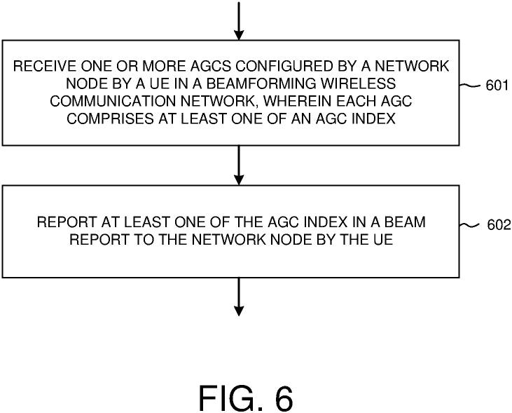

FIG. 6 is a flow chart of a method for beam report from UE perspective in a beamforming wireless communication system in accordance with one novel aspect. In step 601, a UE receives one or more AGCs configured by a network node in the beamforming wireless communication network, wherein each AGC comprises at least one of an AGC index. In step 602, the UE reports at least one of the AGC index in a beam report to the network node. In one example, each AGC comprises at least one of an AGC index, the number of ports of an active panel, and an active panel state. The active panel state indicates that an active panel is selected for an uplink (UL) transmission, a downlink (DL) reception or both of UL transmission and DL reception. the beam report comprises at least one CRI or SSBRI, and each CRI or SSBRI corresponds to a reporting quantity and the AGC index in the beam report.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving one or more antenna group configurations (AGCs) configured by a network node by a user equipment (UE) in a beamforming wireless communication network, wherein each AGC comprises at least one of an AGC index; and
reporting at least one of the AGC index in a beam report to the network node by the UE.

2. The method of claim 1, wherein each AGC further comprises a number of ports or layers that can be supported by the UE.

3. The method of claim 1, wherein the beam report comprises at least one channel-state-information reference-signal (CSI-RS) resource index (CRI) or synchronization signal block (SSB) resource index (SSBRI), and wherein each CRI or SSBRI corresponds to a reporting quantity and the AGC index in the beam report.

4. The method of claim 3, wherein each AGC further comprises an active panel state that indicates whether the UE can perform uplink (UL) transmission to the network node, can perform downlink (DL) reception from the network node, or can perform UL transmission to the network node and DL reception from the network node.

5. The method of claim 4, further comprising:
performing UL transmission to the network node by the UE according to a reference signal that corresponds to a CRI or SSBRI, and wherein the CRI or SSBRI is associated with the AGC that indicates that the UE can perform UL transmission to the network node.

6. The method of claim 4, further comprising:
performing DL reception from the network node by the UE according to a reference signal that corresponds to a CRI or SSBRI, and wherein the CRI or SSBRI is associated with the AGC that indicates that the UE can perform DL reception from the network node.

7. The method of claim 3, wherein the CRIs or SSBRIs associated with different AGCs can be received simultaneously by the UE, and wherein the CRIs or SSBRIs associated with the same AGC cannot be received simultaneously by the UE.

8. The method of claim 1, further comprising:
selecting and activating a panel by the UE according to the AGC in an event that the beam report is associated with one AGC configured by the network node.

9. The method of claim 7, wherein CRIs or SSBRIs in different beam reports associated with different AGCs can be received simultaneously by the UE, wherein the CRIs or SSBRIs in different beam reports associated with the same AGC cannot be received simultaneously by the UE, and wherein the CRIs or SSBRIs in the same beam report cannot be received simultaneously by the UE.

10. The method of claim 1, further comprising:
receiving a set of Transmission Configuration Indicator (TCI) states configured by the network node via a radio resource control (RRC) signaling, wherein each TCI state associates with an AGC.

11. The method of claim 1, further comprising:
reporting a panel-related capability to the network node, wherein the panel-related capability comprises at least one of a maximum number of active panels, a maximum number of panels, a maximum number of configured AGCs, a maximum number of ports or layers of a panel, and a supported active panel state of a panel.

12. A user equipment (UE), comprising:
a receiver that receives one or more antenna group configurations (AGCs) configured by a network node in a beamforming wireless communication network, wherein each AGC comprises at least one of an AGC index; and
a beam report circuit that reports at least one of the AGC index in a beam report to the network node.

13. The UE of claim 12, wherein each AGC further comprises a number of ports or layers that can be supported by the UE.

14. The UE of claim 12, wherein the beam report comprises at least one channel-state-information reference-signal (CSI-RS) resource index (CRI) or synchronization signal block (SSB) resource index (SSBRI), and wherein each CRI or SSBRI corresponds to a reporting quantity and the AGC index in the beam report.

15. The UE of claim 14, wherein each AGC further comprises an active panel state that indicates whether the UE can perform uplink (UL) transmission to the network, can perform downlink (DL) reception from the network node, or can perform UL transmission to the network node and DL reception from the network node.

16. The UE of claim 15, wherein a processor of the UE performs UL transmission to the network node according to a reference signal that corresponds to a CRI or a SSBRI, and wherein the CRI or the SSBRI is associated with the AGC that indicates the UE can perform UL transmission to the network node.

17. The UE of claim 15, wherein a processor of the UE performs DL reception from the network node according to a reference signal that corresponds to a CRI or SSBRI, and wherein the CRI or SSBRI is associated with the AGC that indicates that the UE can perform DL reception from the network node.

18. The UE of claim 14, wherein the receiver can receive the CRIs or SSBRIs associated with different AGCs simultaneously and wherein the receiver cannot receive the CRIs or SSBRIs associated with the same AGC simultaneously.

19. The UE of claim 12, wherein the receiver receives a set of Transmission Configuration Indicator (TCI) states configured by the network node via a radio resource control (RRC) signaling, and wherein each TCI state associates with an AGC.

20. The UE of claim 12, wherein a transmitter of the UE reports a panel-related capability to the network node, wherein the panel-related capability comprises at least one of a maximum number of active panels, a maximum number of panels, a maximum number of configured AGCs, a maximum number of ports or layers of a panel and a supported active panel state of a panel.
